(19) United States
(12) Patent Application Publication
(10) Pub. No.: US 2024/0360536 A1
(43) Pub. Date: Oct. 31, 2024

(54) METHOD FOR RECOVERING MAGNESIUM BY USING SEDIMENT AND SULFURIC ACID GENERATED IN ELECTROLYTIC CHLORINE GENERATION SYSTEM USING SEAWATER AND BRACKISH WATER

(71) Applicant: KNU-INDUSTRY COOPERATION FOUNDATION, Seoul (KR)

(72) Inventors: Kangmin CHON, Seoul (KR); Yong-Gu LEE, Seoul (KR)

(21) Appl. No.: 18/569,062

(22) PCT Filed: Jan. 9, 2023
(86) PCT No.: PCT/KR2023/000373

§ 371 Date: Dec. 11, 2023

(30) Foreign Application Priority Data
Jan. 11, 2022 (KR) 10-2022-0003864
Nov. 17, 2022 (KR) 10-2022-0154549

(51) Int. Cl. C22B 26/22; C01F 5/40; C22B 3/44; C22B 7/00

(52) U.S. Cl. CPC C22B 26/22; C01F 5/40; C22B 3/44; C22B 7/007; C01P 2002/85; C01P 2002/89; C01P 2004/03

(57) ABSTRACT

The present invention relates to a method for recovering magnesium from sediment generated in an electrolytic chlorine generation system using seawater or brackish water, the method comprising the steps of: eluting magnesium by using sulfuric acid in magnesium hydroxide, which is sediment generated in an electrolytic chlorine generation system using seawater and brackish water; precipitating magnesium sulfate by adding an organic solvent to a magnesium-eluted solution; and after the precipitation of the magnesium sulfate, separating the organic solvent and sulfuric acid by using a vacuum evaporation method, and reusing the organic solvent.

### TECHNICAL FIELD

The present invention relates to a method for recovering magnesium from sediment generated in an electrolytic chlorine generation system using seawater and/or brackish water,

### BACKGROUND ART

Magnesium is as strong as steel and 40% lighter than aluminum and is used in a variety of applications due to its high strength-to-weight ratio, durability, impact resistance and structural properties. Magnesium is used as a very important raw material in major domestic industries such as electronics, automobiles, and steel, and the demand for magnesium for producing lightweight, high-quality products is expected to increase significantly in the future. Additionally, the compound has great utility in various industries, including the pharmaceutical industry, agriculture, and construction. Currently, most of the magnesium consumed domestically relies on imports.

The world's terrestrial reserves of magnesium are estimated to be about 3.6 billion tons, and mainly exist as minerals such as magnesite, dolomite, serpentine, and brucite. The concentration of magnesium in seawater is about 1300 mg/L, and considering the entire amount of seawater, the total amount of magnesium present in seawater is 184×10¹⁵ tons, which is about 500,000 times that of land resources.

Methods for recovering magnesium can be broadly divided into methods for recovering magnesium from minerals and methods for recovering magnesium from seawater (including salt water and brackish water). When recovering magnesium from minerals, the magnesium is extracted using acid and then an alkaline substance is added to solidify the magnesium through a precipitation reaction. Methods for recovering magnesium from seawater include precipitation using alkaline substances, use of ion exchange resin, and solvent extraction.

To date, much research has been conducted on recovering magnesium from seawater using alkaline precipitants. The mainly used precipitants were lime, dolomite, NaOH, KOH, NH₄OH, etc., and in most cases, calcium was removed before precipitating magnesium. The biggest difficulty in recovering magnesium using existing alkaline precipitants was precipitating and filtering the resulting magnesium hydroxide. This is because magnesium hydroxide is not only a fine particle but also exhibits low crystallization characteristics.

The technology to produce magnesia (magnesium oxide) by extracting magnesium from seawater has already been commercialized worldwide, but it is not easy to secure economic feasibility, so the development of highly efficient and economical extraction technology is still required. Economics related to the cost of alkali precipitants such as NaOH and NH₄OH can be said to be a major obstacle to commercialization of the technology. Among several ways to solve this problem, discovering an inexpensive precipitant to replace the existing precipitant can be an alternative. For example, alkaline industrial by-products such as paper sludge ash (PSA), cement kiln dust (CKD), slag, and coal ash can be used as precipitants. However, so far, little research has been conducted using industrial by-products as precipitants. Kang et al (2012) only conducted a study to recover magnesium in the form of magnesium hydroxide by adding coal and NaOH to seawater.

The magnesium compounds most commonly used in industry are magnesium chloride (MgCl₂), magnesium hydroxide [Mg(OH)₂], and magnesium sulfate (MgSO₄). Magnesium sulfate is obtained from minerals or artificial synthesis and is mainly manufactured by adding sulfuric acid into magnesium carbonate (MgCO₃) or magnesium oxide (MgO). Magnesium sulfate is very soluble in water. For example, 71 g and 91 g of magnesium sulfate are dissolved in 100 mL of water at 20° C. and 40° C., respectively. However, it is virtually insoluble in alcohol and insoluble in acetone. Meanwhile, magnesium sulfate exists in various forms of hydrate depending on temperature (MgSO₄·xH₂O, x=1˜7), but the heptahydrate salt is the most common form. It is mainly used as paper filler, fire retardant, fertilizer, medicine, etc.

The biggest difficulty in recovering magnesium using existing alkaline precipitants was precipitating and filtering the resulting magnesium hydroxide. This is because magnesium hydroxide is not only a fine particle but also exhibits low crystallization characteristics. The technology to produce magnesia (magnesium oxide) by extracting magnesium from seawater has already been commercialized worldwide, but it is not easy to secure economic feasibility, so the development of highly efficient and economical extraction technology is still required. In particular, economics related to the cost of alkali precipitants such as NaOH and NH4OH can be said to be a major obstacle to commercialization of the technology. In addition, research on separating magnesium from existing seawater mainly consists of recovering magnesium in the form of magnesium hydroxide by adding NaOH to seawater. Research has also been conducted on separating magnesium in the form of magnesium salts by adding acid, but there is an economic problem because the recovery rate is low, and it uses a large amount of acid.

### Prior Patent Literature

Republic of Korea Patent Registration No. 10-1828471

### DISCLOSURE

### Technical Problem

The object of the present invention is to provide a method for recovering magnesium compounds used in industry from sediments generated in an electrolytic chlorine generation system using seawater and brackish water.

Another object of the present invention is to provide magnesium compounds used in industry from sediments generated in an electrolytic chlorine generation system using seawater and brackish water.

### Technical Solution

To achieve the above object, the present invention relates to a method for recovering magnesium from sediment generated in an electrolytic chlorine generation system using seawater or brackish water, comprising:
eluting magnesium using sulfuric acid in magnesium hydroxide, a sediment generated in an electrolytic chlorine generation system using seawater and brackish water;
precipitating magnesium sulfate (MgSO₄·xH₂O(s)) by adding an organic solvent to the magnesium elution solution; and
after precipitating the magnesium sulfate, the organic solvent and sulfuric acid are separated using reduced pressure evaporation and reusing the organic solvent.

In one embodiment of the present invention, the sulfuric acid is preferably waste sulfuric acid or sulfuric acid used in industrial sites but is not limited thereto.

In another embodiment of the present invention, the seawater is preferably seawater concentrate, but is not limited thereto.

In one embodiment of the present invention, in the above method, it is preferable to treat sulfuric acid (H₂SO₄) with sediment generated from an electrolytic chlorine generation system using seawater and brackish water to extract high concentration of magnesium, and then separate the magnesium sulfate using an organic solvent, and
in one embodiment of the present invention, the organic solvent is preferably ethanol or acetone, and more preferably acetone, but is not limited thereto.

In one embodiment of the present invention, in this method, it is preferable to comprise eluting magnesium using 0.5 to 1 M sulfuric acid in magnesium hydroxide, a sediment generated in an electrolytic chlorine generation system and mixing the eluent with the sulfuric acid to ethanol or acetone in a ratio of 1:1.5 to 1:2 (v:v) to precipitate magnesium, and
it is more preferable to comprise eluting magnesium using 0.5 M sulfuric acid in magnesium hydroxide, a sediment generated in an electrolytic chlorine generation system and mixing the eluent with the sulfuric acid to acetone in a ratio of 1:2 (v:v) to precipitate magnesium, but is not limited to thereto.

Additionally, the present invention provides a magnesium compound recovered by the method of the present invention.

In one embodiment of the present invention, the magnesium is preferably magnesium sulfate, but is not limited thereto.

The present invention will be described below.

The present invention is a two-step process of extracting high concentration of magnesium using sulfuric acid (H₂SO₄) and sediment generated in an electrolytic chlorine generation system using seawater and brackish water, and then separating the magnesium sulfate by precipitation using an organic solvent. There is no need for the existing process of generating magnesium hydroxide (Mg(OH)₂) to separate magnesium from seawater or seawater concentrate and since there is a high concentration of magnesium in the sediment generated from the electrolytic chlorine generation system using seawater and brackish water, using a method of the present invention using sulfuric acid can ensure high efficiency recovery rate and economic feasibility.

In addition, in general, as the concentration of sulfuric acid increased, the MgSO₄ precipitation efficiency increased. In the present invention, the amount of precipitation was highest at the lowest concentration, 0.5M sulfuric acid (1.5 g (ethanol) and 1.7 g (acetone) precipitated per 1 g of sediment) and as a result of EDX and XPS, it has the distinction of being able to obtain high purity MgSO₄ by precipitating it in a form free of other inorganic impurities, and the used organic solvent can be reused with a recovery rate (over 99.5%).

### Advantageous Effects

According to the present invention, the present invention is a two-step process of extracting high concentration of magnesium using sulfuric acid (H₂SO₄) and sediment generated in an electrolytic chlorine generation system using seawater and brackish water, and then separating the magnesium sulfate by precipitation using an organic solvent. There is no need for the existing process of generating magnesium hydroxide (Mg(OH)₂) to separate magnesium from seawater or seawater concentrate and since there is a high concentration of magnesium in the sediment generated from the electrolytic chlorine generation system using seawater and brackish water, using a method of the present invention using sulfuric acid can ensure high efficiency recovery rate and economic feasibility. In addition, the present invention has the advantage of reducing the amount of industrial waste generated by using sediment and sulfuric acid generated in an electrolytic chlorine generation system using seawater and brackish water and providing magnesium compounds, which are useful resources widely used in industry.

### DESCRIPTION OF DRAWINGS

FIG. 1 schematically shows a method of recovering magnesium using sulfuric acid and sediment generated in the electrolytic chlorine generation system using seawater and brackish water of the present invention comprising:
a) obtaining sediment generated from an electrolytic chlorine generation system using seawater and brackish water,
b) separating the sediment into dissolved Mg²⁺ and SO4²⁻ using waste sulfuric acid or a sulfuric acid solution,
c) precipitating MgSO₄·xH₂O(s) using an organic solvent (acetone, ethanol, methanol, acetonitrile, isopropyl alcohol, etc.), and
d) after precipitation of MgSO₄·xH₂O(s), separating the organic solvent and sulfuric acid and reusing the separated organic solvent.

FIG. 2 shows the FE-SEM/EDX analysis results of magnesium hydroxide (Mg(OH)₂), a chlorine generation system sediment.

FIG. 3 is a diagram showing the results of XPS analysis of sediment generated in an electrolytic chlorine generation system.

FIGS. 4 and 5 show GC-MS analysis results of the recovered solvents, ethanol (FIG. 4) and acetone (FIG. 5).

### MODE FOR INVENTION

Hereinafter, the present invention will be described in more detail through examples, but these are merely illustrative and are not intended to limit the scope of the present invention. It is obvious to those skilled in the art that the embodiments described below can be modified without departing from the essential gist of the invention.

Overview of the Present Invention: MgSO₄·xH₂O(s) Precipitation Method

The method for recovering magnesium from sediment generated in the electrolytic chlorine generation system using seawater and brackish water of the present invention was carried out in the same order as FIG. 1. In the present invention, the following processes were continuously performed to recover magnesium from sediment generated in an electrolytic chlorine generation system using seawater and brackish water:
1) Step of eluting magnesium from magnesium hydroxide (Mg(OH)₂), a precipitate generated in an electrolytic chlorine generation system using seawater and brackish water, using waste sulfuric acid or sulfuric acid;
2) Precipitating magnesium sulfate (MgSO₄·xH₂O(s)) by adding an organic solvent (99.9% ethanol, 99.9% acetone, 99.9% acetonitrile, 99.9% methanol, 99.9% isopropyl alcohol) to the magnesium elution solution; After the magnesium elution solution and the above five types of organic solvents were mixed in ratios of 1:1, 1:1.5, and 1:2, the optimal organic solvent was selected by comparing the precipitation amount and precipitation efficiency of magnesium sulfate. For precipitation from the mixed solution, it was refrigerated at 3° C. for 12 hours and the precipitated magnesium sulfate and the mixed solution were filtered through GF/F (Glass fiber filter) to separate the magnesium sulfate and the mixed solution, and then magnesium sulfate was dried at 70° C. for 24 hours, and the mass of the dried magnesium sulfate was measured.
3) After precipitation of magnesium sulfate (MgSO₄·xH₂O(s)), the organic solvent and sulfuric acid were separated using reduced pressure evaporation and the organic solvent was reused.

This is detailed below.

### Example 1: Eluting Magnesium

The sediment generated from the electrolytic chlorine generation system using seawater and brackish water was dried at 105° C. for 24 hours, made into powder, and used in a magnesium elution test. The mass of each powder sample was 1.00 g. 50 mL of different concentrations of sulfuric acid (0.5, 1.0, 1.5, 2.0, 2.5 M) were added into each of the five solid samples, and then stirred at 150 rpm for 20 minutes. The reason for using sulfuric acid is to prevent calcium, which interferes with the recovery of magnesium, from eluting together with magnesium by precipitating it as calcium sulfate (CaSO₄). The magnesium eluate using sulfuric acid was filtered using a GF/F filter.

### Example 2: Magnesium Sulfate Precipitation

The magnesium eluate using sulfuric acid filtered in Example 1 and one of five organic solvents (99.9% ethanol, 99.9% acetone, 99.9% acetonitrile, 99.9% methanol, 99.9% isopropyl alcohol) were mixed 1:1. (v:v), 1:1.5 (v:v), and 1:2 (v:v) ratios. For example, 50 mL, 100 mL, and 150 mL of ethanol or acetone were added into 50 mL of magnesium eluate using 0.5 M sulfuric acid. Seventy-five solutions with five different sulfuric acid concentrations, different organic solvent types, and mixing ratios were refrigerated at 3° C. for 12 hours. The resulting solid was filtered using a GF/F filter and then dried at 70° C. The mass of the dry solid was measured and analyzed by FE-SEM/EDX and XPS.

### Example 3: Recovery of Used Organic Solvent

After the solid was precipitated in Example 2, the remaining solution (ethanol and acetone) was placed in a round flask and connected to a vacuum fractionation distillation tube and a condenser. When the solution was boiled in water at 40-47° C., some of the liquid vaporized and separated. The solution separated by vaporization was analyzed by GC-MS.

The results of the above examples are as follows.

### X-Ray Fluorescence (XRF) Spectroscopy Analysis Results (Analysis of Sediment Constituent Elements)

Table 1 below shows the XRF analysis results of sediment generated in the electrolytic chlorine generation system using seawater and brackish water of the present invention.

Referring to Table 1, the main constituent of the sediment is composed of magnesium (Mg, 69.5 wt %), and additionally calcium (Ca, 5.1 wt %), silicon (Si, 0.6 wt %), sodium (Na, 0.3 wt %), chlorine (Cl, 4.2 wt %) and sulfur (S, 0.5 wt %), indicating that these elements can coprecipitate when producing chlorine using seawater or brackish water.

In addition, Mg comprised in the sediment has a relatively lower solubility constant than calcium hydroxide (Ca(OH)₂, solubility constant=5.5×10⁻⁶), and exists in the form of magnesium hydroxide (Mg(OH)₂, solubility constant=5.61×10⁻¹²) (Zheng, L.; Xuehua, C.; Mingshu, T. Hydration and setting time of MgO-type expansive cement. Cem. Concr. Res. 1992, 22, 1-5).

TABLE 1

| Element | Na | Mg | Si | Ca | S | Cl |
|---|---|---|---|---|---|---|
| wt % | 0.3 | 69.5 | 0.6 | 5.1 | 0.5 | 4.2 |

Table 1 shows the results of analysis of the constituent elements of sediment generated in an electrolytic chlorine generation system using seawater and brackish water using XRF.

### FE-SEM/EDX Analysis Results of Sediment

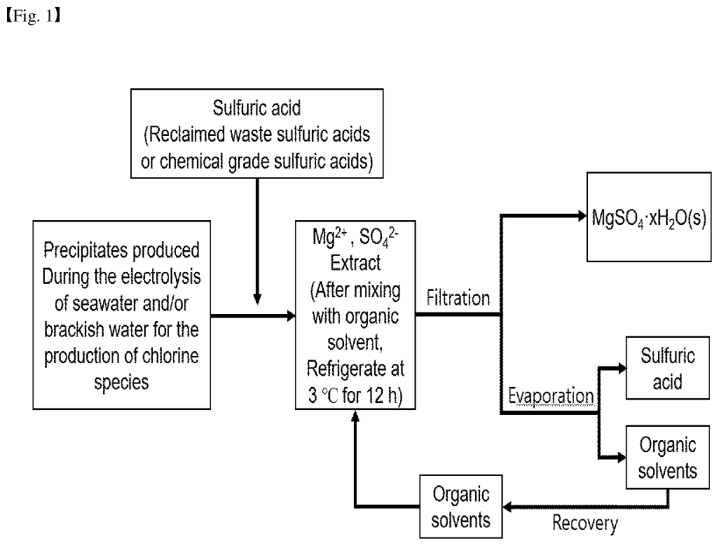

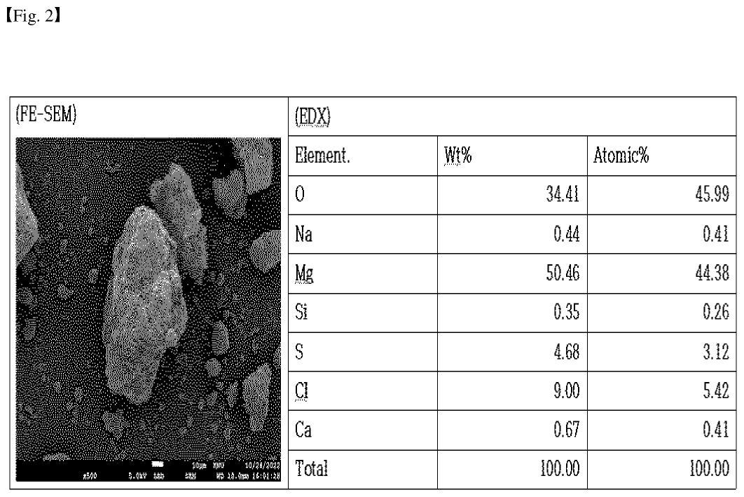

FIG. 2 is a Field emission-scanning electron microscope (FE-SEM) image and Energy dispersive X-ray (EDX) spectrum analysis results of sediment generated in the electrolytic chlorine generation system using seawater and brackish water of the present invention.

Referring to FIG. 2, the surface of the sediment showed an irregular mineral shape, and EDX results showed that the main elements are composed of oxygen (45.99%) and magnesium (44.38%). This is consistent with the results of XRF and indicates that magnesium hydroxide is the dominant component of the sediment.

### XPS Analysis Results of Sediment

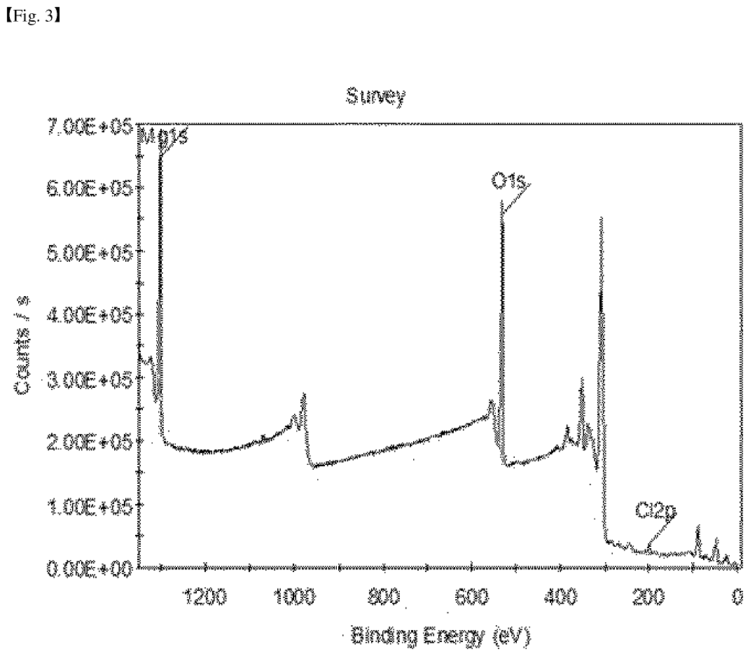

FIG. 3 shows the results of X-ray Photoelectron Spectroscopy (XPS) analysis of sediment generated in the electrolytic chlorine generation system using seawater and brackish water of the present invention.

Referring to FIG. 3, the main elements of the sediment were found to be composed of magnesium and oxygen. This is consistent with the results in Table 1 and FIG. 2 and indicates that magnesium hydroxide (Mg(OH)₂) is the dominant component of the sediment.

### Magnesium Sulfate Precipitation

The results of precipitation experiments conducted by varying the sulfuric acid concentration of the eluate and the type of organic solvent are summarized in Table 2.

Referring to Table 2 below, when looking at the amount of magnesium sulfate (MgSO₄) precipitated according to the change in sulfuric acid concentration (0.5-2.5M) of the eluate obtained by dissolving 1 g of the precipitate in sulfuric acid and the changing conditions of the mixing ratio (1:1; 1:1.5; 1:2) with five types of organic solvents, under 0.5 M sulfuric acid conditions, a 1:1.5 mixing ratio of ethanol and acetone (precipitation efficiency: ethanol=68%; acetone=97%) and a 1:2 mixing ratio (precipitation efficiency: ethanol=150%; acetone=170%) and under 1.0 M sulfuric acid conditions, a 1:2 mixing ratio (precipitation efficiency: ethanol=108%; acetone=127%).

The optimal conditions for precipitating magnesium sulfate from sediment generated in an electrolytic chlorine generation system using seawater and brackish water are as follows. It is preferable to elute the precipitate using 0.5˜1.0 M sulfuric acid and mix the eluate with one of two organic solvents (ethanol and acetone) at a ratio of 1:1.5-1:2 (v:v) to precipitate magnesium sulfate. Most preferably, elution is performed using 0.5M sulfuric acid and mixing with acetone in a ratio of 1:2 (v:v) to precipitate magnesium sulfate.

TABLE 2

| | | | | | Precipitation | | |
|---|---|---|---|---|---|---|---|
| | | Mass of precipitated | | | efficiency per | | |
| | | material (g) | | | gram of extract (%) | | |
| | | Sulfuric | | | Sulfuric | | |
| | Sulfuric | acid(vol.):organic | | | acid(vol.):organic | | |
| Organic | acid Conc. | solvent (Vol) | | | solvent (Vol) | | |
| solvent | (M) | 1:1 | 1:1.5 | 1:2 | 1:1 | 1:1.5 | 1:2 |
| Ethanol | 0.5 | 0.08 | 0.68 | 1.50 | 8 | 68 | 150 |
| | 1.0 | 0.08 | 0.08 | 1.08 | 8 | 8 | 108 |
| | 1.5 | 0.09 | 0.08 | 0.08 | 9 | 8 | 8 |
| | 2.0 | 0.09 | 0.09 | 0.09 | 9 | 9 | 9 |
| | 2.5 | 0.09 | 0.09 | 0.08 | 9 | 9 | 8 |
| Acetone | 0.5 | 0.09 | 0.97 | 1.70 | 9 | 97 | 170 |
| | 1.0 | 0.09 | 0.1 | 1.27 | 9 | 10 | 127 |
| | 1.5 | 0.09 | 0.04 | 0.27 | 9 | 4 | 27 |
| | 2.0 | 0.10 | 0.08 | 0.40 | 10 | 8 | 40 |
| | 2.5 | 0.09 | 0.10 | 0.08 | 9 | 10 | 8 |
| Acetonitrile | 0.5 | 0.07 | 0.07 | 0.07 | 7 | 7 | 7 |
| | 1.0 | 0.08 | 0.08 | 0.08 | 8 | 8 | 8 |
| | 1.5 | 0.09 | 0.09 | 0.08 | 9 | 9 | 8 |
| | 2.0 | 0.08 | 0.09 | 0.08 | 8 | 9 | 8 |
| | 2.5 | 0.09 | 0.09 | 0.08 | 9 | 9 | 8 |
| Methanol | 0.5 | 0.07 | 0.11 | 0.06 | 7 | 11 | 6 |
| | 1.0 | 0.09 | 0.08 | 0.06 | 9 | 8 | 6 |
| | 1.5 | 0.09 | 0.08 | 0.08 | 9 | 8 | 8 |
| | 2.0 | 0.09 | 0.08 | 0.08 | 9 | 8 | 8 |
| | 2.5 | 0.08 | 0.09 | 0.09 | 8 | 9 | 9 |
| Isopropyl | 0.5 | 0.08 | 0.10 | 0.16 | 8 | 10 | 16 |
| alcohol | 1.0 | 0.08 | 0.11 | 0.10 | 8 | 11 | 10 |
| | 1.5 | 0.09 | 0.10 | 0.16 | 9 | 10 | 16 |
| | 2.0 | 0.11 | 0.10 | 0.12 | 11 | 10 | 12 |
| | 2.5 | 0.10 | 0.21 | 0.09 | 10 | 21 | 9 |

Table 2 is a table comparing precipitation amount and precipitation efficiency according to sulfuric acid concentration and organic solvent mixing ratio.

XPS Analysis Results after Magnesium Sulfate Precipitation

As a result of XPS analysis after magnesium sulfate precipitation, the qualitative analysis of the precipitate showed that magnesium sulfate (MgSO₄) was the main component and was consistent with the SEM-EDX results.

### GC-MS Analysis Results of Recovered Solvent

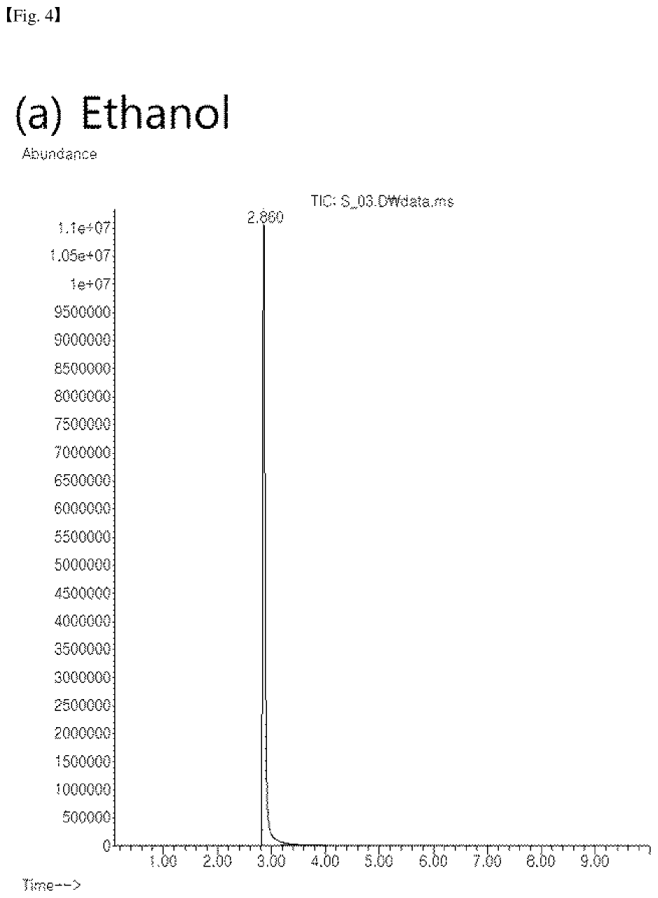

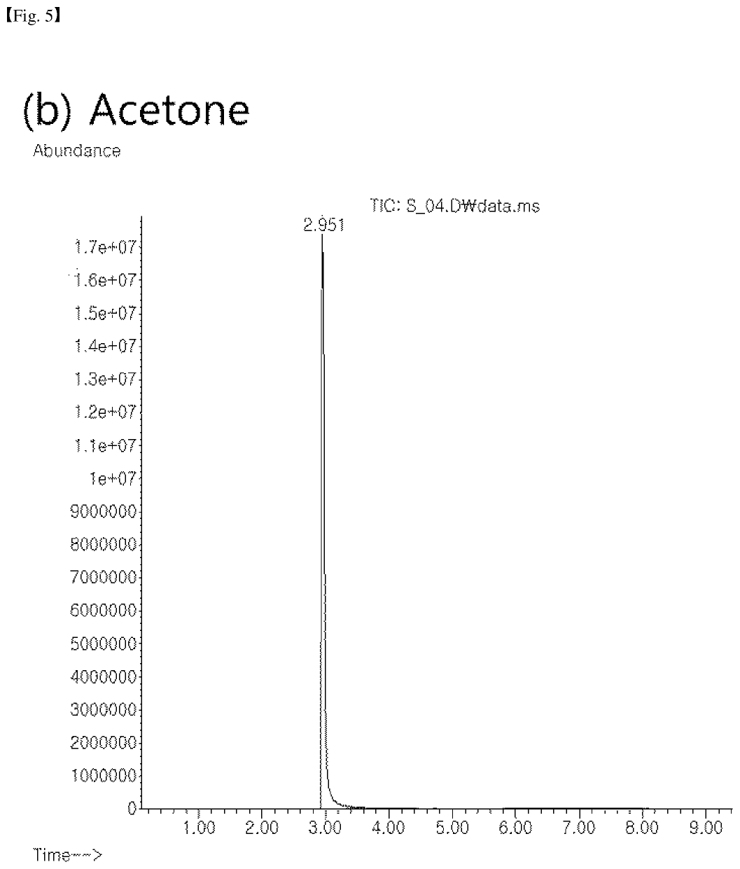

FIGS. 4 and 5 show GC-MS analysis results of the recovered solvents, (a) ethanol and (b) acetone. After precipitation of magnesium sulfate as described above, the filtered solution was separated by distillation under reduced pressure. It was recovered at a reduced pressure of less than 100 hpa and a water bath temperature of 40-47° C. The recovered solvent was analyzed using GC-MS, and the results showed that both ethanol and acetone were 99.9%, which is consistent with the purity of the solvent before use. Additionally, the volume of the recovered solvent was maintained at more than 99.5% of the volume of the solvent used for precipitation. It is believed that recovering and reusing the ethanol and acetone used to precipitate magnesium sulfate will greatly help improve economic efficiency.

1. A method for recovering magnesium from sediment generated in an electrolytic chlorine generation system using seawater or brackish water, comprising:
eluting magnesium using sulfuric acid in magnesium hydroxide, a sediment generated in an electrolytic chlorine generation system using seawater and brackish water;
precipitating magnesium sulfate (MgSO₄·xH₂O(s)) by adding an organic solvent to the magnesium elution solution; and,
after precipitating the magnesium sulfate, the organic solvent and sulfuric acid are separated using reduced pressure evaporation and reusing the organic solvent.

2. The method of claim 1, wherein the sulfuric acid is waste sulfuric acid.

3. The method of claim 2, wherein the waste sulfuric acid was generated at industrial sites.

4. The method of claim 1, wherein the method comprises the step of treating sediment generated from an electrolytic chlorine generation system using seawater and brackish water with sulfuric acid (H₂SO₄) to extract high concentration of magnesium, and then separating the magnesium sulfate using an organic solvent.

5. The method of claim 1, wherein the seawater is seawater concentrate.

6. The method of claim 1, wherein the organic solvent is ethanol or acetone.

7. (canceled)

8. The method of claim 1, wherein the method comprises eluting magnesium using 0.5 to 1 M sulfuric acid in magnesium hydroxide, a sediment generated in an electrolytic chlorine generation system and mixing the eluent with the sulfuric acid to ethanol or acetone in a ratio of 1:1.5 to 1:2 (v:v) to precipitate magnesium.

9. The method of claim 8, wherein the method comprises eluting magnesium using 0.5 M sulfuric acid in magnesium hydroxide, a sediment generated in an electrolytic chlorine generation system and mixing the eluent with the sulfuric acid to acetone in a ratio of 1:2 (v:v) to precipitate magnesium.

10. A magnesium compound recovered by the method of claim 1.

11. The magnesium compound according to claim 10, wherein the magnesium compound is magnesium sulfate.

12. The magnesium compound according to claim 10, wherein the sulfuric acid is waste sulfuric acid.

13. The magnesium compound according to claim 12, wherein the waste sulfuric acid was generated at industrial sites.

14. The magnesium compound according to claim 10, wherein the seawater is seawater concentrate.

15. The magnesium compound according to claim 10, wherein the organic solvent is ethanol or acetone.
